(19) United States
(12) Patent Application Publication
(10) Pub. No.: US 2020/0280446 A1
(43) Pub. Date: Sep. 3, 2020

(54) SERVICE USAGE APPARATUS, METHOD THEREFOR, AND NON-TRANSITORY COMPUTER-READABLE STORAGE MEDIUM

(71) Applicant: CANON KABUSHIKI KAISHA, Tokyo (JP)

(72) Inventor: Kiyonori Matsumoto, Kawasaki-shi (JP)

(21) Appl. No.: 16/796,729

(22) Filed: Feb. 20, 2020

(30) Foreign Application Priority Data
Feb. 28, 2019 (JP) 2019-036849

(51) Int. Cl. H04L 9/32; H04L 9/08

(52) U.S. Cl. CPC H04L 9/3234; H04L 9/3228; H04L 9/0819; H04L 9/0861; H04L 9/3247

(57) ABSTRACT

A service usage apparatus transmits, to an external authentication device, a request for generation of a key pair to be used for authentication required to use a service which is provided via a network, and stores public key information received from the external authentication device. Then, in response to a request for key generation received from the network, the service usage apparatus transmits the stored public key information to the service providing system without performing further communication with the external authentication device.

### BACKGROUND

### Field of the Disclosure

Aspects of the present disclosure generally relate to a technique concerning an authentication system using, for example, biometric authentication.

### Description of the Related Art

Heretofore, as an authentication system alternative to password authentication, authentication processing using biological information, such as fingerprints, has started to be used.

Recently, Fast Identity Online (FIDO) has appeared, which is a technique serving as an example of a new authentication method and is an alternative to password authentication, which has been heretofore used as an authentication method for a web service. FIDO is an authentication protocol that is based on biometric authentication. In this authentication method, since authentication processing is performed without biological information being transmitted to the outside via a network, it is possible to prevent leakage of biological information about users. Furthermore, in addition to FIDO, as a new authentication method, there is a contrivance which pre-registers, for example, a public key, user information, and terminal information with a server and performs authentication using a challenge and response method.

Japanese Patent Application Laid-Open No. 2018-6896 discusses a technique concerning registration of a public key and a terminal with a server in an authentication system using FIDO.

In the case of using the above-mentioned new authentication method, the user is required to preliminarily register a public key with an authentication system located on a network drive.

With regard to registration of a public key, at the timing of reception of a predetermined request from the authentication system, in association with registration of biological information performed by the user on a terminal for use in authentication, a pair including a public key and a private key is generated by the terminal. Then, data including the generated public key is transmitted from the terminal to the authentication system, so that registration processing for the public key is performed by the authentication system. In the technique discussed in Japanese Patent Application Laid-Open No. 2018-6896, similarly, when the user registers a new terminal for use in authentication with a server, a pair including a public key and a private key is also generated in association with registration of biological information at the time of reception of a predetermined request from the authentication system.

On the other hand, when the user uses the above-mentioned new authentication method, respective different apparatuses may be employed as a mobile apparatus, such as a tablet, which the user uses to access a web service and a terminal which the user uses for authentication (an external authentication device). In the case of using the external authentication device, the user becomes able to use, for example, biometric authentication which does not depend on, for example, the specifications of the mobile apparatus.

On the other hand, in the above-mentioned registration processing, a communication between the mobile apparatus and the external authentication device often needs to be established at the timing of reception of a predetermined request for the registration processing from the authentication system. Accordingly, in a case where the external authentication device is not located near the user when the user wants to cause the mobile apparatus to access a web service, the user may not be able to start the above-mentioned registration processing.

### SUMMARY

According to an aspect of the present disclosure, a service usage apparatus includes at least one memory storing instructions, and at least one processor that executes the instructions to cause the service usage apparatus to, in a case where an external authentication device is connected to the service usage apparatus, transmit, to the external authentication device, a request for generation of a key pair to be used for authentication, receive, from the external authentication device, identification information and public key information which correspond to the key pair which is generated in response to the request in a case where authentication processing performed by the external authentication device is successful, store the received identification information and the received public key information, and in response to a request for information required for authentication from a service providing system, which provides a service via the network, transmit the stored public key information to the service providing system without performing communication with the external authentication device.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration of an exemplary embodiment of the present disclosure.

FIGS. 2A, 2B, 2C, and 2D are diagrams illustrating examples of hardware configurations of the respective apparatuses or devices in the exemplary embodiment.

FIGS. 3A, 3B, 3C, 3D, and 3E are diagrams illustrating examples of the respective functional blocks in the exemplary embodiment.

FIGS. 4A, 4B, 4C, 4D, and 4E are diagrams illustrating examples of data structures which are used in registration processing to be performed prior to service usage.

FIG. 5 is a sequence diagram illustrating registration processing to be performed prior to service usage.

FIG. 6 is a diagram illustrating examples of screens used to prompt the user to complete registration processing, each of which is displayed on a mobile apparatus.

FIG. 7 is a diagram illustrating examples of screens used to notify the user of completion of the registration processing, each of which is displayed on the mobile apparatus.

FIG. 8 is a sequence diagram illustrating processing which is performed concerning a public key between the mobile apparatus and an external authentication device.

FIG. 9 is a sequence diagram illustrating authentication processing which is performed at the time of service usage using the mobile apparatus.

FIG. 10 is a sequence diagram illustrating authentication processing which is performed at the time of service usage using a peripheral device.

FIGS. 11A and 11B are diagrams illustrating examples of data structures which are used in authentication processing.

### DESCRIPTION OF THE EMBODIMENTS

Various exemplary embodiments, features, and aspects of the disclosure will be described in detail below with reference to the drawings.

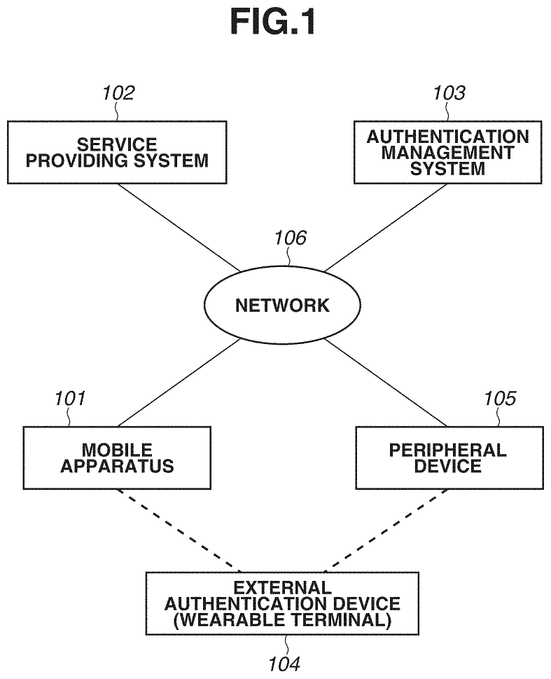

FIG. 1 is a diagram illustrating an example of a system configuration of an exemplary embodiment of the present disclosure. The present system includes a mobile apparatus 101, a service providing system 102, an authentication management system 103, an external authentication device 104, a peripheral device 105, and a network 106. The service providing system 102 and the authentication management system 103 can be implemented by a single integrated system.

The mobile apparatus 101, the service providing system 102, the authentication management system 103, and the peripheral device 105 are connected to the network 106, and are able to communicate with each other. The network 106 is what is called a communication network, which is any one of, for example, a local area network (LAN), a wide area network (WAN) such as the Internet, a telephone line, a dedicated digital line, an automated teller machine (ATM) line, a frame relay line, a cable television line, and a data broadcasting wireless circuit line or is implemented by a combination of some of these lines.

The mobile apparatus 101 and the external authentication device 104 or the peripheral device 105 and the external authentication device 104 have a configuration capable of communicating with each other as needed by the user via, for example, short-range wireless communication typified by Bluetooth® or Near Field Communication (NFC) or Universal Serial Bus (USB) connection.

The mobile apparatus 101, such as a smartphone, is merely an example in the present exemplary embodiment and can be any form of a service usage apparatus as long as it is an apparatus which is used by a user who is to be authenticated in the present system, to which an external authentication device is able to be connected, and with which a service provided by the service providing system 102 is able to be used via a network. Specifically, the mobile apparatus 101 is, for example, a tablet apparatus, a notebook personal computer (PC), an ATM, a digital home electrical appliance, or an automobile. The external authentication device 104 is also an apparatus which is used by a user who is to be authenticated in the present system, and is, for example, a wearable terminal of the wristwatch type or eyeglass type. The external authentication device 104 includes a sensor which detects biological information, such as fingerprint information, iris information, or heart rate information, specific to the user. The peripheral device 105 is an apparatus capable of performing processing in cooperation with the service providing system 102, and is, for example, a data output apparatus such as a printing apparatus.

In the exemplary embodiment described below, a cloud print service for printing content such as a document or image is taken as an example of a service which the service providing system 102 provides. Furthermore, the service providing system 102 is similarly able to provide other various services. For example, such other various services include a storage service for uploading data and then storing the data, a conversion service for converting uploaded data into a desired output format, a service for generating and editing content, and a data delivery service for delivering content for playback of music or moving images.

The authentication management system 103 is a system provided to manage registration information such as public keys.

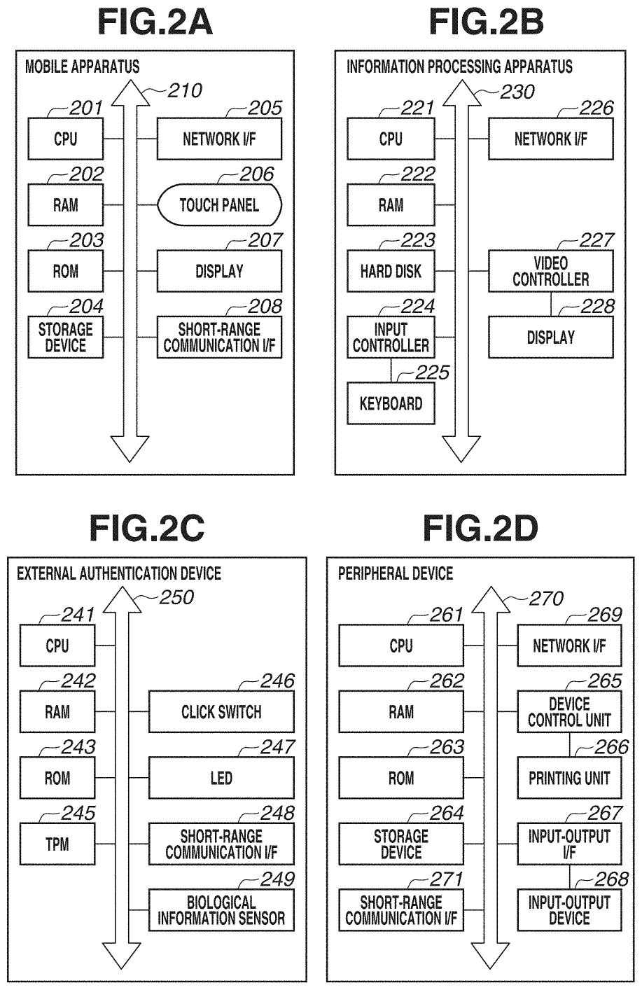

FIGS. 2A, 2B, 2C, and 2D are diagrams illustrating examples of hardware configurations of the respective apparatuses or devices in the present exemplary embodiment.

FIG. 2A illustrates an example of a hardware configuration of the mobile apparatus 101. A central processing unit (CPU) 201 executes programs, such as programs stored in a read-only memory (ROM) 203 and an operating system (OS) and applications loaded from a storage device 204 onto a random access memory (RAM) 202. Thus, the CPU 201 executes the programs stored in a readable storage medium, thus functioning as processing units for performing respective processing operations illustrated in sequence diagrams described below. The RAM 202 is a main memory for the CPU 201, and functions as, for example, a work area. A touch panel 206 is an input device of the mobile apparatus 101, and the CPU 201 detects an operation performed on the touch panel 206 to control the programs. Furthermore, the input device of the mobile apparatus 101 is not limited to a touch panel. A display 207 is one of the output devices of the mobile apparatus 101, and the CPU 201 displays, for example, a result of each type of operation on the display 207, thus notifying the user of such a result. A network interface (I/F) 205 is connected to the network 106, and performs intercommunication with an apparatus or device connected to the network 106. A short-range communication I/F 208 is an interface (I/F) which performs inputting and outputting for short-range communication such as Bluetooth® or NFC, and performs intercommunication with an apparatus or device connected thereto. The respective constituent elements of the mobile apparatus 101 are connected to an internal bus 210, thus being able to perform intercommunication with each other. The short-range communication I/F 208 can be equipped with an I/F for USB (not illustrated). Moreover, the short-range communication I/F 208 can also be equipped with a storage unit having an anti-tamper property such as a tamper proof module (TPM).

FIG. 2B illustrates an example of an information processing apparatus which configures each of the service providing system 102 and the authentication management system 103.

A CPU 221 executes programs, such as an operating system (OS) and applications loaded from a hard disk 223 onto a RAM 222. The CPU 221 executes the program stored in a readable storage medium, thus functioning as processing units for performing respective processing operations illustrated in sequence diagrams described below. The RAM 222 is a main memory for the CPU 221, and functions as, for example, a work area. An input controller 224 controls operation inputs entered from a keyboard 225 and a pointing device (not illustrated), such as a mouse, a tach pad, or a trackball. A video controller 227 controls display outputs provided by, for example, a display 228. A network I/F 226 is connected to the network 106, and performs control processing for communication with an apparatus or device connected to the network 106.

Moreover, each of the service providing system 102 and the authentication management system 103 can be configured with a plurality of information processing apparatuses or can be provided by a virtual machine which is implemented on an information processing apparatus.

FIG. 2C illustrates an example of a hardware configuration of the external authentication device 104. A CPU 241 executes programs, such as an operating system (OS) and applications stored in a ROM 243. Thus, the CPU 241 executes the programs stored in a readable storage medium, thus functioning as processing units for performing respective processing operations illustrated in sequence diagrams described below. A RAM 242 is a main memory for the CPU 241, and functions as, for example, a work area. A click switch 246 is an input device of the external authentication device 104, and the CPU 241 detects an operation performed on the click switch 246 and thus performs program control, such as starting pairing. A light-emitting diode (LED) 247 is one of output devices of the external authentication device 104, and the CPU 241 operates the LED 247 to notify the user of, for example, the state of the external authentication device 104 such as the current pairing state of the external authentication device 104. A short-range communication I/F 248 is an interface (I/F) which performs inputting and outputting for short-range communication such as Bluetooth® or NFC, and performs intercommunication with an apparatus or device connected thereto. A TPM 245 is a storage unit equipped with an anti-tamper property to prevent stored data from being read from the outside, for the purpose of processing or storing confidential information. In the present exemplary embodiment, the feature amount of biological information entered by the user and a private key that is associated with the biological information are stored in the TPM 245, and are thus prevented from leaking to the outside. A biological information sensor 249 is a sensor which reads biological information about the user, and converts information about, for example, the fingerprint, iris, vein, or an electrocardiogram of the user into a read signal. The short-range communication I/F 248 can be equipped with an I/F for USB (not illustrated). The respective constituent elements of the external authentication device 104 are connected to an internal bus 250, thus being able to perform intercommunication with each other.

FIG. 2D illustrates an example of a hardware configuration of the peripheral device 105. A CPU 261 executes programs, such as programs stored in a ROM 263 and an operating system (OS) and applications loaded from a storage device 264 onto a RAM 262. Thus, the CPU 261 executes the programs stored in a readable storage medium, thus functioning as processing units for performing respective processing operations illustrated in sequence diagrams described below. The RAM 262 is a main memory for the CPU 261, and functions as, for example, a work area. The storage device 264 is, for example, a hard disk or flexible disk which stores various pieces of data. A network I/F 269 exchanges data with an external network device in a unidirectional way or bidirectional way. A short-range communication I/F 271 is a network interface (I/F) for short-range communication such as NFC or Bluetooth®. The peripheral device 105 is able to exchange data with the external authentication device 104 with use of the short-range communication I/F 271. A device control unit 265 controls a printing unit 266. An input-output device 268 represents a plurality of configurations playing the functions of inputting and outputting in the peripheral device 105. Specifically, the input-output device 268 receives an input entered from the user (for example, a button input) and communicates a signal corresponding to the received input to the above-mentioned various processing units via an input-output I/F 267. Besides, a display device (for example, a touch panel) used to provide necessary information to the user or receive a user operation is included in the input-output device 268. Additionally, a scan device used to read a document and receive electronic data as an input can also be included in the input-output device 268. Additionally, the input-output device 268 can be equipped with an I/F for USB (not illustrated).

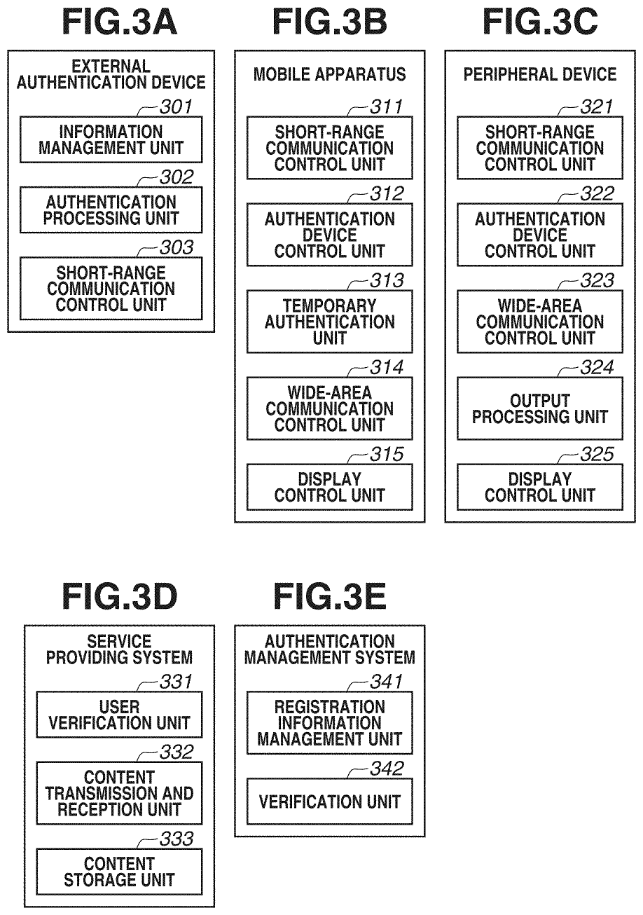

FIGS. 3A, 3B, 3C, 3D, and 3E are diagrams illustrating examples of the respective functional blocks representing functions which are implemented by software in the respective apparatuses and devices in the present exemplary embodiment.

FIG. 3A illustrates functional blocks of the external authentication device 104. An information management unit 301 manages, via the TPM 245, biological information for use in authentication, a public key which is generated in association with the biological information, and a private key. Moreover, the information management unit 301 also has the function of generating a public key and a private key. An authentication processing unit 302 performs biometric authentication processing by comparing the feature amount (biological information) that is based on a signal read by the biological information sensor 249 with biological information stored in the TPM 245. A short-range communication control unit 303 controls communication which is performed with an external apparatus, such as the mobile apparatus 101, with use of the short-range communication I/F 248 or a USB I/F.

FIG. 3B illustrates functional blocks of the mobile apparatus 101. A short-range communication control unit 311 controls communication which is performed with an external apparatus, such as the external authentication device 104, with use of the short-range communication I/F 208 or a USB I/F. An authentication device control unit 312 selects an authentication device which the user uses, or manages information about the authentication device. A temporary authentication unit 313 performs, for example, a request for key generation to the external authentication device 104. Moreover, the temporary authentication unit 313 manages information about, for example, a public key. A wide-area communication control unit 314 controls communication which is performed with use of the network OF 205. A display control unit 315 controls displaying which is performed with use of the display 207.

FIG. 3C illustrates functional blocks of the peripheral device 105. A short-range communication control unit 321 controls communication with, for example, the external authentication device 104 or the mobile apparatus 101 using, for example, the short-range communication I/F 271. An authentication device control unit 322 controls exchange of, for example, an authentication request to an authentication device connected via the short-range communication I/F 271. A wide-area communication control unit 323 controls communication which is performed with use of the network I/F 269. An output processing unit 324 controls output processing for content data which is performed with use of the printing unit 266 or the network I/F 269. Besides, the output processing unit 324 also controls playback output processing for content data which is performed with use of a touch panel or a loudspeaker (not illustrated) of the input-output device 268. A display control unit 325 controls displaying which is performed with use of the input-output device 268.

FIG. 3D illustrates functional blocks of the service providing system 102. A user verification unit 331 receives registration of users and cooperates with the authentication management system 103 to implement authentication.

A content transmission and reception unit 332 receives content serving as a service to be provided from a registered user or transmits (provides) such content to the outside. A content storage unit 333 stores and retains content.

FIG. 3E illustrates functional blocks of the authentication management system 103. A registration information management unit 341 manages registration information about users. The registration information includes information concerning public keys. A verification unit 342 performs verification of a signature using a public key.

Here, processing which is performed in the present exemplary embodiment is configured with the following three processing operations when roughly divided.
Registration processing to be performed prior to service usage.
Authentication processing to be performed at the time of service usage using a mobile apparatus.
Authentication processing to be performed at the time of service usage using a peripheral device.

These processing operations are described with reference to the drawings.

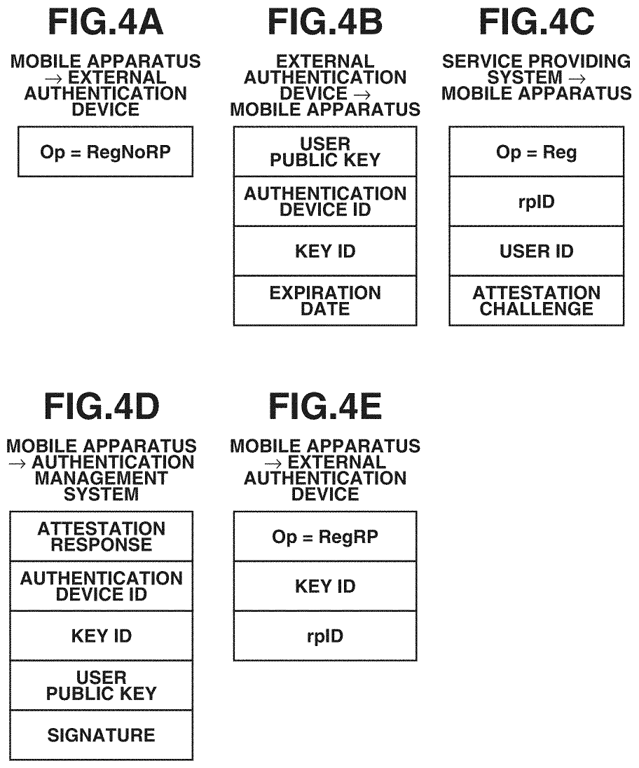

Furthermore, FIGS. 4A, 4B, 4C, 4D, and 4E illustrate examples of data structures such as formats of requests and responses in the respective processing operations.

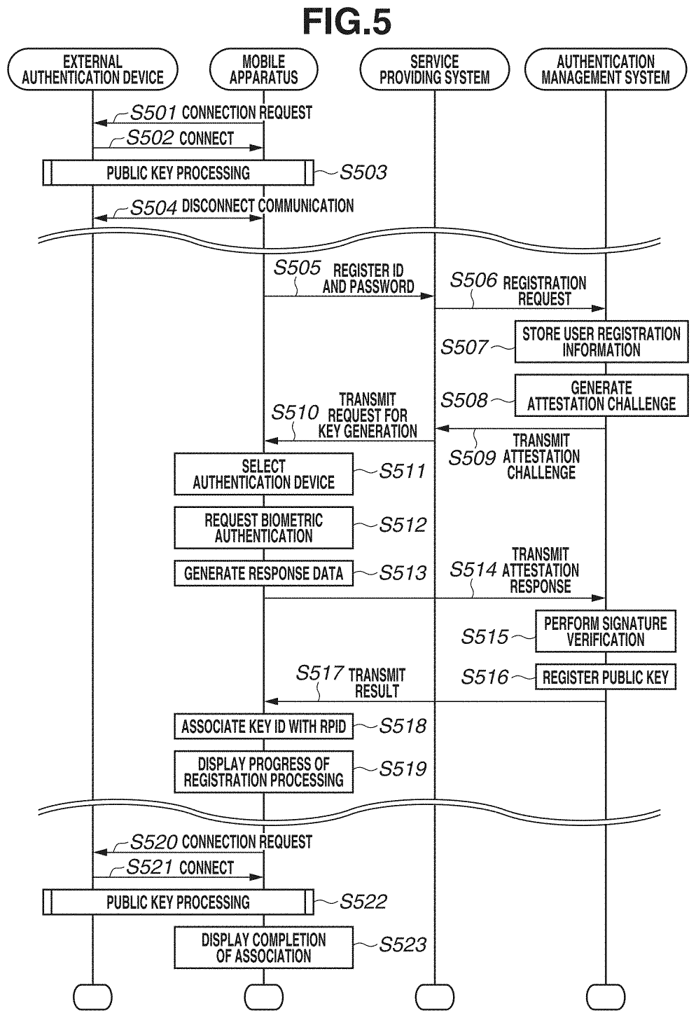

First, “registration processing to be performed prior to service usage” is described. FIG. 5 illustrates an example of a sequence of this registration processing.

In step S501 to step S502, the short-range communication control unit 311 of the mobile apparatus 101 and the short-range communication control unit 303 of the external authentication device 104 operate in conjunction with each other and enter a state capable of performing intercommunication with each other. For example, in the case of Bluetooth®, this processing operation corresponds to a general flow called pairing. Peer-to-peer communication connection using, for example, USB can also be established.

In step S503, after establishment of intercommunication, the temporary authentication unit 313 of the mobile apparatus 101 requests the external authentication device 104 to generate one or more pairs each including a public key and a private key. At this time, the mobile apparatus 101 is not accessing, for example, the service providing system 102 or the authentication management system 103. A relying party (RP) is implemented for each service which the service providing system 102 provides, and pieces of identification information (relying party identifiers (RPIDs)) different for respective services are assigned thereto. Therefore, an RPID can be an ID specific to a business operator which provides a service or specific to a business, and, generally, a fully qualified domain name (FQDN) of a service providing business operator is used therefor.

FIG. 4A illustrates contents of a generation request to be transmitted from the mobile apparatus 101 to the external authentication device 104. An operation code (Op) is set to “RegNoRP”, which indicates a request for key generation without being associated with any RP.

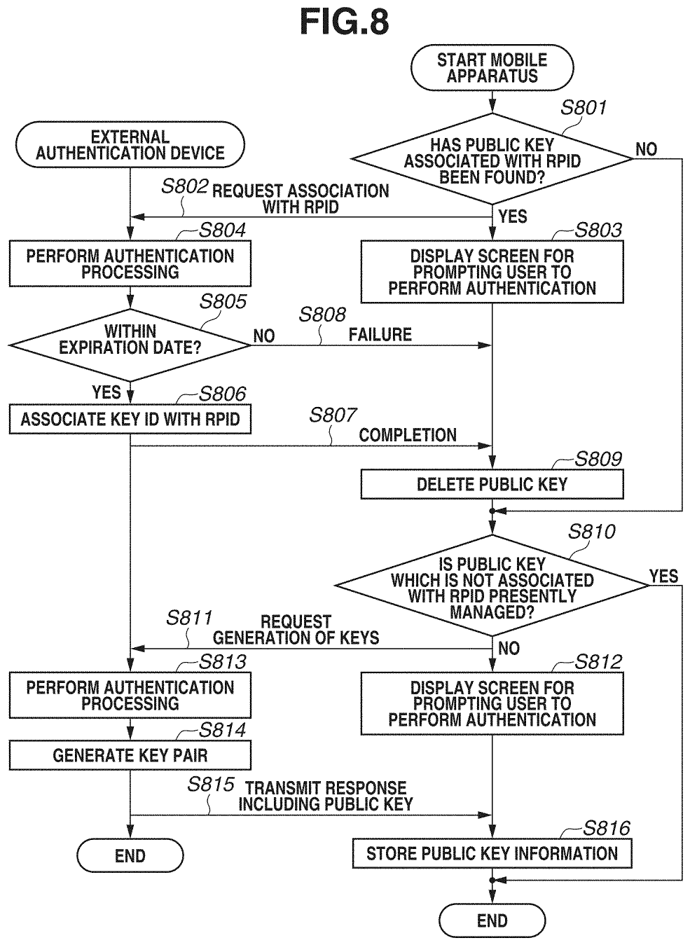

In step S503, moreover, in a case where, in the external authentication device 104 having received a request illustrated in FIG. 4A, the authentication processing unit 302 has received biological information about the user with use of the biological information sensor 249, the information management unit 301 generates a pair including a public key and a private key. Here, since the information management unit 301 has generated a key pair without association with a particular RPID, the information management unit 301 sets an expiration date with respect to the generated keys. Moreover, the short-range communication control unit 303 transmits, to the mobile apparatus 101, a response including the generated public key, an authentication device ID for identifying the external authentication device 104, a key ID, and an expiration date (FIG. 4B). Furthermore, details of processing in step S503 are further described below with reference to the sequence diagram of FIG. 8.

Information which the information management unit 301 of the external authentication device 104 manages is shown in Table A and Table B.

TABLE A

| | | | Biological | |
|---|---|---|---|---|
| Key ID | Private key | Public key | information | Expiration date |
| KEY01 | 4acab6e7 | d3e39967 | As39z0d3 | |
| KEY02 | 89abcdef | 124578ab | 39nNeiII | |
| KEY03 | deadbeef | 12312312 | NInCa2as | 2018 Jan. 1 |

In table A, the key ID is an ID for uniquely identifying a pair including a public key and a private key. Moreover, the biological information represents the feature amount that is based on a signal read by the biological information sensor 249, and can be binary data obtained by collecting feature vectors of the biological information about the user. The expiration date is information to be assigned to a key which is not associated with an RPID. A key pair which has exceeded the expiration date without association being performed is caused to lapse as being expired. The authentication processing unit 302 compares biological information about the user entered via the biological information sensor 249 with the registered biological information, then performs authentication by determining whether the two pieces of biological information have similar features, and further determines whether the user has the ownership of keys.

TABLE B

| RPID | Key ID |
|---|---|
| example.com | KEY01 |
| example.net | KEY02 |
| example.org | KEY02 |

In Table B, RPID represents identification information corresponding to a service which the service providing system 102 provides. Table B indicates that, with respect to three services, key IDs corresponding to public keys registered in association with the respective services are managed. This means that the same public key has been registered with respect to two different services “example.net” and “example.org”.

From Table A and Table B, it can be seen that a key pair the key ID of which is “KEY03” has been generated according to the request illustrated in FIG. 4A.

Table C represents information concerning a public key which the temporary authentication unit 313 of the mobile apparatus 101 manages.

TABLE C

| Key ID | Public key | Authentication device ID | Expiration date |
|---|---|---|---|
| KEY03 | deadbeef | AUTH01 | 2018 Jan. 1 |
| KEYZZ | Aaaabbbb | AUTH02 | 2018 Jan. 5 |

A record which the key ID identifies with “KEY03” represents information which was stored in the case of reception of a response illustrated in FIG. 4B. A record which the key ID identifies with “KEYZZ” represents information about a public key which was registered when the mobile apparatus 101 used a different external authentication device.

In the present exemplary embodiment, in step S504, a connection between the external authentication device 104 and the mobile apparatus 101 is cancelled.

Next, in step S505, in response to a user operation, the mobile apparatus 101 accesses a website concerning a service which the service providing system 102 provides, and starts a user registration. On this occasion, registration information such as a user ID (for example, an e-mail address of an individual person) and a password, which are identification information about a user entered by the user into the mobile apparatus 101, is transmitted from the mobile apparatus 101 to the website. This operation does not need to be performed following the above-mentioned operations performed in step S501 to step S504. Additionally, in the present exemplary embodiment, suppose that the external authentication device 104 is not located near the mobile apparatus 101 and, during a period until later processing in step S519, the mobile apparatus 101 and the external authentication device 104 are not able to communicate with each other.

In step S506, the user verification unit 331 of the service providing system 102 transmits, to the authentication management system 103, a registration request for a user registration using the registration information received in step S505. In step S507, the registration information management unit 341 stores the registration information, which includes a user ID and a password, in a storage which is implemented by a storage device such as the hard disk 223. Moreover, in step S508, the verification unit 342 generates an attestation challenge. The attestation challenge is generated usually by use of a random byte sequence. In step S509, the authentication management system 103 transmits, as a response, the attestation challenge to the service providing system 102.

In step S510, the user verification unit 331 of the service providing system 102 transmits, to the mobile apparatus 101, a request for key generation including the attestation challenge (FIG. 4C).

As illustrated in FIG. 4C, operation code (Op) for the request for key generation is set to “Reg”. Moreover, this request includes an RPID, which is identification information corresponding to the service, a user ID, and an attestation challenge.

In step S511, upon receiving the request for key generation via the wide-area communication control unit 314, the authentication device control unit 312 of the mobile apparatus 101 checks (searches for) an external authentication device which is currently connected or is connectable to the mobile apparatus 101. Then, the authentication device control unit 312 presents, as a list of authentication devices, a list including information corresponding to found external authentication devices and information corresponding to the temporary authentication unit 313 to the user. Here, since there is no connection to any external authentication device, only the information corresponding to the temporary authentication unit 313 is presented. Then, the authentication device control unit 312 receives, from the user, selection of any authentication device from the presented information.

In step S512, the authentication device control unit 312 requests the selected authentication device to perform authentication processing accompanied by key generation. In the case of the present exemplary embodiment, since the temporary authentication unit 313 is selected, a request for authentication processing accompanied by key generation is performed to the temporary authentication unit 313.

In response to this request, the temporary authentication unit 313 uses previously-acquired public key information which is not associated with any RPID. Here, as a result, biometric authentication processing using the external authentication device 104 and generation processing for a private key and a public key are skipped. Such displaying as to prompt the user to perform biometric authentication is also not performed.

In step S513, the temporary authentication unit 313 generates response data using a previously-acquired public key which is not associated with any RPID. Here, the response data is generated by use of public key information and an authentication device ID corresponding to the key ID “KEY03”, which is managed in Table C. Moreover, the temporary authentication unit 313 digitally signs the attestation challenge with an encryption key. Response data generated by including, for example, a key ID, public key information, an authentication device ID, and a digital signature is referred to as an “attestation response”, which is illustrated in FIG. 4D.

In step S514, the temporary authentication unit 313 transmits the attestation response as the response data. This response data is transmitted to the authentication management system 103 via the service providing system 102.

In step S515, the verification unit 342 of the authentication management system 103 verifies a signature included in the attestation response transmitted from the mobile apparatus 101.

Here, a signature included in the attestation response is supplementarily described.

An encryption key to be used for signature generation by the temporary authentication unit 313 can be replaced by a common key. In this case, it is necessary to previously pass this common key to the external authentication device 104 in step S503, encrypt the common key with an attestation private key, and manage the encrypted common key in association with the key ID “KEY03” managed in Table C. The attestation private key is a key which is prepared by a providing source of the external authentication device 104 for each model of authentication device, and is managed as a certificate at, for example, a trusted execution environment (TEE) of the external authentication device 104. In such a case, the temporary authentication unit 313 causes the attestation response to include a key ID, public key information, an authentication device ID, a digital signature using a common key, and a common key encrypted with an attestation private key. The verification unit 342 of the authentication management system 103 decrypts the encrypted common key included in the response data with use of an attestation public key, thus extracting a common key. The verification unit 342 verifies a signature with use of the extracted common key. Specifically, the verification unit 342 performs a comparison between hashes and checks whether a hash decrypted with the common key and a hash of data transmitted from the mobile apparatus 101 coincide with each other. Moreover, the verification unit 342 checks whether an attestation challenge included in response data obtained by decryption processing coincides with an attestation challenge generated by the verification unit 342 itself in step S508. If the two attestation challenges coincide with each other, the verification unit 342 determines that the signature is successfully verified.

Alternatively, the temporary authentication unit 313 can manage and use an attestation private key as a private key for use in a signature. In this case, the temporary authentication unit 313 generates a signature using an attestation private key, and the verification unit 342 of the authentication management system 103 verifies the signature with use of an attestation public key.

In step S516, in response to the verification performed in step S515 being successful, the registration information management unit 341 stores, as shown in Table D, the key ID, the authentication device ID, and the public key information in association with the user ID.

TABLE D

| | | | Authentication | |
|---|---|---|---|---|
| User ID | Password | Key ID | device ID | Public key |
| Tanaka | Pw01 | KEY03 | AUTH01 | deadbeef |
| Suzuki | Pw02 | KEYXX | AUTHXX | 00000000 |
| Takahashi | Pw03 | KEYYY | AUTHYY | 11111111 |

Password in Table D represents a password obtained by hashing a password entered when the above-mentioned user registration was performed, with use of a hash function.

In step S517, the authentication management system 103 transmits, to the mobile apparatus 101, a notification indicating that registration of the public key has been normally completed. Furthermore, in a case where the verification performed in step S515 is unsuccessful, registration of the public key is not performed, so that the authentication management system 103 transmits a registration error notification to the mobile apparatus 101.

In step S518, the temporary authentication unit 313 of the mobile apparatus 101 stores an RPID (“NewService.com”) and a user ID in association with the previously-used key ID (“KEY03”), as shown in Table E.

TABLE E

| KeyID | RPID | User ID |
|---|---|---|
| KEY03 | NewService.com | Tanaka |

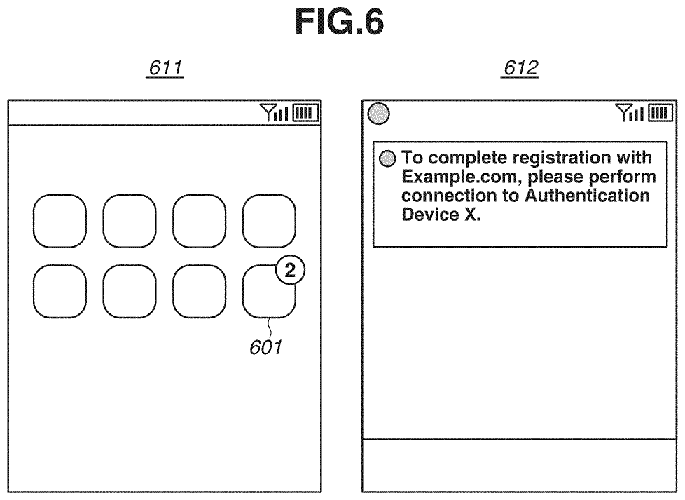

In step S519, the display control unit 315 of the mobile apparatus 101 performs displaying concerning the progress of a registration operation for service usage as illustrated in FIG. 6. Further registering the information stored in Table E with the external authentication device 104 enables the user to use authentication to be performed at the external authentication device 104 at the time of using a service which the service providing system 102 provides. Therefore, the display control unit 315 displays, to the user, a message for prompting the user to connect to the external authentication device 104.

As an example of displaying by the display control unit 315, the number of public keys the association of which caused by connection to the external authentication device 104 is presented at an icon 601 of an application used for communicating with external authentication devices, as illustrated in a screen 611. This enables prompting the user to re-perform communication with an external authentication device. Additionally, a message indicating that registration with an authentication device for service usage is not yet completed, as illustrated in a screen 612, can be communicated to the user. In a case where registration with an authentication device for usage of a plurality of services is not yet completed, displaying the names of the respective services or presenting the number of services enables prompting the user to re-perform communication with an external authentication device.

Next, in step S520 and step S521, procedures similar to those described above in step S501 and step S502 are performed, so that the external authentication device 104 and the mobile apparatus 101 enter a state capable of communicating with each other. In step S522, the temporary authentication unit 313 of the mobile apparatus 101 requests the information management unit 301 of the external authentication device 104 to reflect association of a public key and an RPID added on Table E therein. Processing in step S520 and subsequent steps does not need to be immediately performed following a user operation for performing processing in step S505 to step S519. Such processing only needs to be performed at any time within the above-mentioned expiration date.

FIG. 4E is a diagram illustrating the contents of a request to be transmitted from the mobile apparatus 101 to the external authentication device 104 in step S522. The request includes, in addition to operation code “RegRP”, which indicates additional registration of an RPID, a key ID and an RPID associated with the key ID.

In response to the request, the information management unit 301 of the external authentication device 104 adds a key ID and an RPID included in the request to Table B. After that, the external authentication device 104 notifies the mobile apparatus 101 of completion of the association. Details of step S522 are further described below with reference to FIG. 8.

In step S523, the display control unit 315 of the mobile apparatus 101 displays a message indicating that registration with an authentication device for service usage has been completed, thus notifying the user of the message.

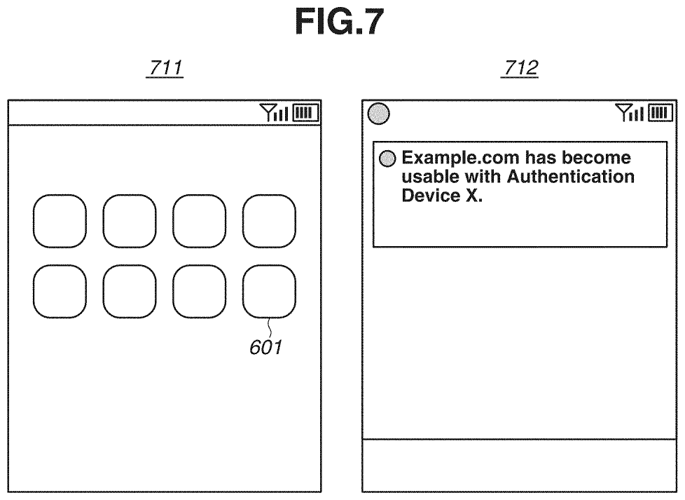

FIG. 7 illustrates an example of displaying which is performed in step S523. In a screen 711 illustrated in FIG. 7, it can be seen that the number which has been appended to the icon 601 in the screen 611 illustrated in FIG. 6 has disappeared. Causing a transition of displaying in this way can serve as a notification of the completion. Moreover, the display control unit 315 can display, while indicating the name of a predetermined service, a message indicating that the service has become usable with the external authentication device 104, as in a screen 712 illustrated in FIG. 7.

Furthermore, in FIG. 5, step S501 to step S504, step S505 to step S519, and step S520 to step S523 do not need to be performed in a temporal or spatially consecutive manner. For example, it could be possible that processing in step S501 to step S504 is performed at work, processing in step S505 to step S519 is performed at home after work, and processing in step S520 to step S523 is performed at work again the next day.

FIG. 8 is a sequence diagram illustrating details of processing which is performed between the mobile apparatus 101 and the external authentication device 104 in each of step S503 and step S522 described above with reference to FIG. 5. For example, each time a connection between the mobile apparatus 101 and the external authentication device 104 is established, the processing illustrated in FIG. 8 is performed, so that, as a result, one of step S503 and step S522 or both step S503 and step S522 are performed.

First, processing concerning step S522 is described as step S801 to step S809, and, then, processing concerning step S503 is described as step S810 to step S816.

In step S801, the temporary authentication unit 313 of the mobile apparatus 101 refers to the above-mentioned Table E to determine if a new RPID has been newly associated with a KEY ID and then searches Table C for a public key stored in association with the external authentication device 104. If a public key stored in association with the connected external authentication device 104 has been found (YES in step S801), the processing proceeds to step S802, and, if such a public key has not been found (NO in step S801), the processing proceeds to step S810.

In step S802, the temporary authentication unit 313 transmits the request illustrated in FIG. 4E to the external authentication device 104. Moreover, in step S803, the display control unit 315 of the mobile apparatus 101 displays a screen for prompting the user to perform biometric authentication with the external authentication device 104.

In step S804, the information management unit 301 of the external authentication device 104 receives inputting of biological information from the user and then performs authentication processing. Furthermore, with regard to the authentication processing, in the case of fingerprint authentication, processing such as template matching that is based on image information is performed. With regard to authentication processing using another type of biological information, matching processing of another method is performed.

In a case where authentication is successful in step S804, the information management unit 301 confirms that a key ID that is based on the biological information and a key ID included in the request coincide with each other. Moreover, the information management unit 301 also confirms that any RPID is not associated with the key ID. Then, in step S805, the information management unit 301 determines whether a public key associated with the key ID is within an expiration date. If the public key is within the expiration date (YES in step S805), the processing proceeds to step S806. In step S806, pursuant to the request from the mobile apparatus 101, the information management unit 301 additionally registers the key ID and an RPID with respect to the above-mentioned Table B, thus performing registration of the association. On this occasion, the information management unit 301 deletes an expiration date corresponding to the key ID managed in the above-mentioned Table A. In step S807, the short-range communication control unit 303 transmits, to the mobile apparatus 101, a notification indicating that association with an RPID has been completed.

On the other hand, if, in step S805, it is determined that a public key associated with the key ID has exceeded the expiration date (NO in step S805), then in step S808, the short-range communication control unit 303 transmits, to the mobile apparatus 101, a notification indicating that association with an RPID has been failed due to the expiration date being exceeded.

In step S809, in response to the response transmitted from the external authentication device 104, the temporary authentication unit 313 of the mobile apparatus 101 deletes information about, for example, a key ID targeted for the request in step S802, the corresponding public key, and the corresponding RPID from Table C and Table E.

In step S810, the temporary authentication unit 313 of the mobile apparatus 101 refers to Table C and then determines whether the mobile apparatus 101 is managing a public key which is not associated with any RPID. On this occasion, the temporary authentication unit 313 also checks the number of public keys each of which is not associated with any RPID and the expiration date of each public key. The temporary authentication unit 313 can be designed in such a way as to manage up to a predetermined number of public keys each of which is not associated with an RP owned by the temporary authentication unit 313 itself. If, in step S810, the temporary authentication unit 313 determines that a predetermined number of public keys each of which is not associated with any RPID and the expiration date of each of which is still sufficiently far to be reached (for example, several days being left) are not currently managed (NO in step S810), the processing proceeds to step S811, and, if the temporary authentication unit 313 determines that such a predetermined number of public keys are currently managed (YES in step S810), the processing ends.

In step S811, the temporary authentication unit 313 transmits, to the external authentication device 104, a request for key generation such as that illustrated in FIG. 4A. Furthermore, on this occasion, the temporary authentication unit 313 is able to request the external authentication device 104 to generate up to the above-mentioned number of pairs each including a public key and a private key. The temporary authentication unit 313 is also able to transmit a request for key generation on a pair-by-pair basis. Moreover, in step S812, the display control unit 315 of the mobile apparatus 101 displays a screen for prompting the user to perform biometric authentication with the external authentication device 104.

In step S813, the authentication processing unit 302 of the external authentication device 104 receives inputting of biological information from the user and then performs authentication processing. In step S814, the information management unit 301 of the external authentication device 104 generates a key pair including a public key and a private key. The key pair is associated with a key ID. Moreover, here, since a key pair is generated without being associated with any specific RPID, an expiration date is set to each key.

In step S815, the short-range communication control unit 303 transmits, to the mobile apparatus 101, a response including the generated public key, an authentication device ID for identifying the external authentication device 104, a key ID, and an expiration date, such as that illustrated in FIG. 4B.

In step S816, the temporary authentication unit 313 of the mobile apparatus 101 stores information included in the response in Table C and then ends the processing.

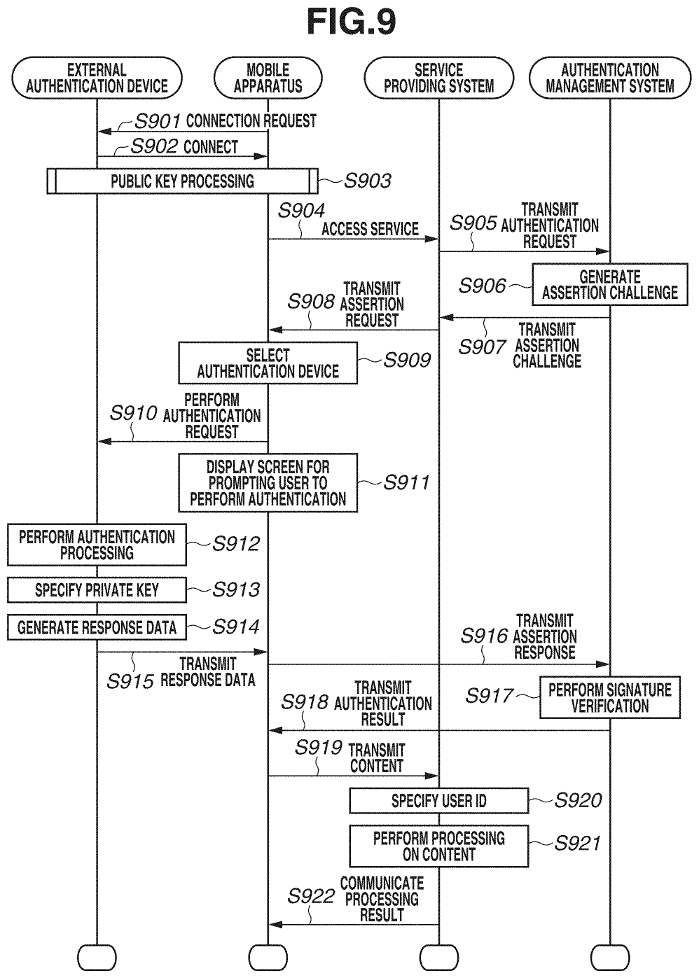

Next, “authentication processing to be performed at the time of service usage using a mobile apparatus” is described with reference to a sequence diagram illustrated in FIG. 9.

In step S901 and step S902, the external authentication device 104 and the mobile apparatus 101 enter a state capable of communicating with each other. Then, in step S903, the processing described with reference to FIG. 8 is performed.

In step S904, pursuant to a user operation, the mobile apparatus 101 accesses the service providing system 102 with use of an application such as web browser. In step S905, the service providing system 102 transmits an authentication request to the authentication management system 103 to perform authentication required for service usage.

In step S906, the verification unit 342 of the authentication management system 103 generates an assertion challenge. In step S907, the authentication management system 103 transmits the assertion challenge to the service providing system 102. The assertion challenge is a byte sequence which is generated in a random manner. The assertion challenge is later used for verification processing. Furthermore, the assertion challenge can be stored with an expiration date thereof set, and can be made invalid (failed in authentication) when the expiration date is exceeded.

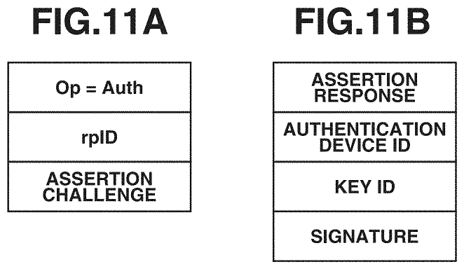

In step S908, the service providing system 102 transmits, to the mobile apparatus 101, an assertion request including an assertion challenge illustrated in FIG. 11A.

Referring to FIG. 11A, operation code (Op) indicates “Auth”, which represents an assertion request including authentication processing. As illustrated in FIG. 11A, the assertion request includes an RPID and an assertion challenge.

In step S909, upon receiving the assertion request, the authentication device control unit 312 of the mobile apparatus 101 checks (searches for) an external authentication device which is currently connected or is connectable to the mobile apparatus 101. In a case where a plurality of authentication devices has been found, the authentication device control unit 312 displays such a result on the display 207 and then allows the user to select one authentication device from the plurality of authentication devices. Here, suppose that the external authentication device 104 has been selected.

In step S910, the authentication device control unit 312 of the mobile apparatus 101 transmits an authentication request to the external authentication device 104. The authentication request includes the RPID and the assertion challenge, which have been included in the assertion request. Along with the authentication request, in step S911, the display control unit 315 displays, on the display 207, a screen for prompting the user to perform authentication with the external authentication device 104.

In step S912, the authentication processing unit 302 of the external authentication device 104 receives inputting of biological information from the user and then performs authentication processing. On this occasion, authentication that is based on biological information corresponding to an RPID included in the authentication request is performed. In a case where authentication is successful, in step S913, the information management unit 301 refers to Table A and Table B and then identifies an RPID and a key ID and a private key, which are managed in association with biological information which has been used for authentication processing.

On the other hand, in a case where authentication processing that is based on biological information entered from the user is failed, no private key is specified, a failure in authentication is communicated to the mobile apparatus 101, and processing illustrated in the sequence diagram of FIG. 9 is interrupted, so that the processing ends.

In step S914, the information management unit 301 generates a digital signature with use of the specified private key and the assertion challenge and thus generates an assertion response including the signature, such as that illustrated in FIG. 11B. In step S915, the external authentication device 104 transmits the generated response data to the mobile apparatus 101.

In step S916, the wide-area communication control unit 314 of the mobile apparatus 101 transmits the assertion response to the authentication management system 103 via the service providing system 102.

In step S917, the verification unit 342 of the authentication management system 103 refers to Table D and then specifies a public key based on a key ID included in the assertion response. The verification unit 342 verifies a signature included in the assertion response with use of the specified public key. Specifically, in a case where the assertion challenge obtained from the specified public key and the signature included in the assertion response coincides with the assertion challenge generated in step S906, the verification unit 342 determines that verification of the signature is successful.

In a case where such verification is successful, in step S918, the verification unit 342 generates, as an authentication result, data including an authentication token corresponding to a user ID associated with the key ID, and then transmits the generated data to the mobile apparatus 101 via the service providing system 102. The authentication token is a token such as that typified by, for example, JSON Web Token (JWT). With the processing performed so far, authentication processing required to use a service which the service providing system 102 provides is completed.

In step S919, pursuant to a user operation, the wide-area communication control unit 314 of the mobile apparatus 101 transmits content to the service providing system 102. On this occasion, the wide-area communication control unit 314 also transmits an authentication token obtained as a result of authentication together with the content.

In step S920, the user verification unit 331 of the service providing system 102 verifies the authentication token and thus specifies a user ID with use of the token. In step S921, the content transmission and reception unit 332 processes the received content. For example, in a case where a storage service of the service providing system 102 is used, as shown in Table F, the received content is stored in association with the specified user ID (“Tanaka”). Then, in step S922, the content transmission and reception unit 332 communicates, to the mobile apparatus 101, a processing result indicating, for example, save successful.

TABLE F

| User ID | Content ID | Content |
|---|---|---|
| Tanaka | Pw01 | Xxx.doc |
| Suzuki | Pw02 | Yyy.pdf |
| Takahashi | Pw03 | Zzz.ps |

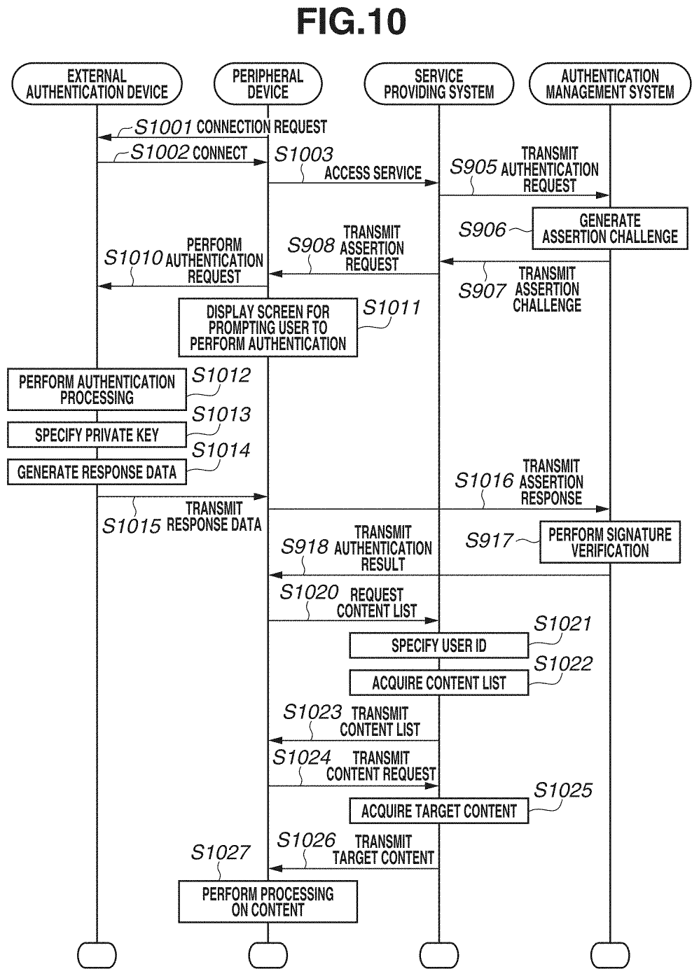

Next, “authentication processing to be performed at the time of service usage using the peripheral device 105” is described with reference to the sequence diagram of FIG. 10. Processing operations assigned the same reference characters as those in FIG. 9 are processing operations similar thereto and, therefore, omitted from description here.

In step S1001 and step S1002, the external authentication device 104 and the peripheral device 105 enter a state capable of communicating with each other. Such a connection is established in response to a user operation performed on the peripheral device 105. For example, using Near Field Communication (NFC) enables reducing a load on a pairing work between the external authentication device 104 and the peripheral device 105.

In step S1003, the user operates a web browser of the peripheral device 105 to cause the peripheral device 105 to access the service providing system 102.

After that, processing operations similar to those described above with reference to FIG. 9 are performed, so that the peripheral device 105 receives an assertion request.

In step S1010, the authentication device control unit 322 of the peripheral device 105 transmits an authentication request to the external authentication device 104. The authentication request includes an RPID and an assertion challenge, which have been included in the assertion request. Along with the authentication request, in step S1011, the display control unit 325 displays, on the touch panel of the input-output device 268, a screen for prompting the user to perform authentication with the external authentication device 104.

In step S1012, the authentication processing unit 302 of the external authentication device 104 receives biological information from the user and then performs authentication processing. On this occasion, authentication that is based on biological information corresponding to an RPID included in the authentication request is performed. In a case where authentication is successful, in step S1013, the information management unit 301 refers to Table A and Table B and then identifies an RPID and a key ID and a private key, which are managed in association with biological information which has been used for authentication processing.

On the other hand, in a case where authentication processing that is based on biological information entered from the user is failed, no private key is specified, a failure in authentication is communicated to the mobile apparatus 101, and processing illustrated in the sequence diagram of FIG. 10 is interrupted, so that the processing ends.

In step S1014, the information management unit 301 generates a digital signature with use of the specified private key and the assertion challenge and thus generates an assertion response including the signature, such as that illustrated in FIG. 11B. In step S1015, the external authentication device 104 transmits the generated response data to the peripheral device 105.

In step S1016, the wide-area communication control unit 323 of the peripheral device 105 transmits the assertion response to the authentication management system 103 via the service providing system 102.

After that, processing operations similar to those described above with reference to FIG. 9 are performed, so that the peripheral device 105 receives an authentication result.

In step S1020, pursuant to a user operation, the wide-area communication control unit 323 of the peripheral device 105 makes a request for a content list associated with the user to the service providing system 102. This request includes an authentication token included in the authentication result assigned thereto.

In step S1021, the user verification unit 331 of the service providing system 102 verifies the authentication token and thus specifies a user ID with use of the token. In step S1022, the content storage unit 333 refers to Table F and then acquires a content list including IDs of one or more contents which are managed in association with user IDs. In step S1023, the service providing system 102 transmits the content list to the peripheral device 105.

In step S1024, the display control unit 325 of the peripheral device 105 displays a content selection screen with use of the received content list. Moreover, in a case where a content is selected by the user via the content selection screen, the wide-area communication control unit 323 transmits a content request including an ID of the selected content to the service providing system 102. The content request includes an authentication token included in the above-mentioned authentication result assigned thereto.

In step S1025, the user verification unit 331 of the service providing system 102 verifies the authentication token and then acquires content data corresponding to the ID of the designated content from a storage. In step S1026, the content transmission and reception unit 332 of the service providing system 102 transmits the targeted content data to the peripheral device 105.

In step S1027, the output processing unit 324 of the peripheral device 105 performs output processing of the acquired content data. For example, in the present exemplary embodiment, the output processing includes print outputting of image content and playback outputting of music content or still image or moving image content.

### Modification Example

As mentioned above, in the present exemplary embodiment, information about a public key the association of which has been completed in step S807 is deleted in step S809. However, this processing in step S809 is not essential. The mobile apparatus 101 and the external authentication device 104 are able to re-use the acquired public key for a plurality of targets and thus associate the acquired public key with a plurality of RPIDs. Even if a plurality of RPIDs is associated with the same key ID, it is possible to identify the key ID and perform a flow of biometric authentication.

Additionally, in the present exemplary embodiment, a public key with an expiration date set thereto is used. This management is also not essential. In that case, the user will not have to become concerned about any expiration date of the public key, so that it becomes possible to further improve usability.

Moreover, a configuration in which the processing itself illustrated in FIG. 8 is performed each time the mobile apparatus 101 and the external authentication device 104 connect to each other has been described above. However, a configuration in which processing in step S810 to step S816 illustrated in FIG. 8 is performed in response to, for example, a user instruction issued onto a dedicated screen (an application for implementing the temporary authentication unit 313) of the mobile apparatus 101 can be employed. Moreover, in such a case, the processing in step S810 to step S816 can be omitted at the time of connection between the mobile apparatus 101 and the external authentication device 104.

### Application Example 1

While, in the present exemplary embodiment, for example, a cloud print service has been described as an example, the service which the service providing system provides is not limited to such a service. Since the service providing system is able to provide a service associated with the user, for example, the service providing system is able to manage address books and provide an address book associated with the user in response to authentication.

### Application Example 2

In the present exemplary embodiment, as an example of the peripheral device 105, an output and playback apparatus for content, such as an image processing apparatus, has been taken as a specific example. However, as an example of the peripheral device 105, besides, the present disclosure can also be applied to a door system which controls locking and unlocking of a door. For example, even in the case of a door system in which a short-range communication device, such as an NFC device, is located near a door and the door is opened and closed in response to the state of user authentication, a biometric authentication device owned by an individual user can be used to issue an instruction to open and close the door.

The present disclosure should be interpreted to include an apparatus, a system, or a method configured by combining the above-described exemplary embodiments as appropriate.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-036849 filed Feb. 28, 2019, which is hereby incorporated by reference herein in its entirety.

What is claimed is:

1. A service usage apparatus comprising:
at least one memory storing instructions; and
at least one processor that executes the instructions to cause the service usage apparatus to:
in a case where an external authentication device is connected to the service usage apparatus, transmit, to the external authentication device, a request for generation of a key pair to be used for authentication;
receive, from the external authentication device, identification information and public key information which correspond to the key pair which is generated in response to the request, in a case where authentication processing performed by the external authentication device is successful;
store the received identification information and the received public key information; and
in response to a request for information required for authentication from a service providing system, which provides a service via the network, transmit the stored public key information to the service providing system without performing communication with the external authentication device.

2. The service usage apparatus according to claim 1, wherein the stored public key information is managed with use of an expiration date.

3. The service usage apparatus according to claim 1, wherein, in a case where service information corresponding to the service has been received from the service providing system, the service information is stored in association with the identification information and the public key information.

4. The service usage apparatus according to claim 3, wherein the instructions further cause the service usage apparatus to, in a case where the external authentication device has been connected to the service usage apparatus, transmit, to the external authentication device, the identification information and the service information stored in association with the identification information.

5. The service usage apparatus according to claim 4, wherein the instructions further cause the service usage apparatus to, in a case where the transmitted service information has been associated with the identification information by the external authentication device, delete the public key information stored in the service usage apparatus.

6. The service usage apparatus according to claim 1, wherein the instructions further cause the service usage apparatus to:
in a case where a request for authentication has been received from the service providing system when the service usage apparatus has accessed the service providing system to use the service, perform an authentication request to the external authentication device; and
in a case where a response including a signature generated by authentication processing performed by the external authentication device in response to the authentication request has been received from the external authentication device, transmit the received response to the service providing system,
wherein, in a case where authentication using the signature and the transmitted public key information is successful, the service usage apparatus is able to use the service.

7. A method for a service usage apparatus, the method comprising:
in a case where an external authentication device is connected to the service usage apparatus, transmitting, to the external authentication device, a request for generation of a key pair to be used for authentication;
receiving, from the external authentication device, identification information and public key information which correspond to the key pair which is generated in response to the request in a case where authentication processing performed by the external authentication device is successful;
storing the received identification information and the received public key information; and
in response to a request for information required for authentication from a service providing system, which provides a service via the network, transmitting the stored public key information to the service providing system without performing communication with the external authentication device.

8. A non-transitory computer-readable storage medium having computer-executable instructions stored thereon, wherein the instructions cause a computer as a service usage apparatus to:
in a case where an external authentication device is connected to the service usage apparatus, transmit, to the external authentication device, a request for generation of a key pair to be used for authentication;
receive, from the external authentication device, identification information and public key information which correspond to the key pair which is generated in response to the request in a case where authentication processing performed by the external authentication device is successful;
store the received identification information and the received public key information; and
in response to a request for information required for authentication from a service providing system, which provides a service via the network, transmit the stored public key information to the service providing system without performing communication with the external authentication device.
